(19) United States
(12) Patent Application Publication
(10) Pub. No.: US 2025/0370844 A1
(43) Pub. Date: Dec. 4, 2025

(54) METHODS AND SYSTEMS FOR DETERMINING ANOMALY AND FAULT IN OPEN PLATFORM COMMUNICATIONS (OPC) DATA

(71) Applicant: Honeywell International Inc., Charlotte, NC (US)

(72) Inventor: Ganesh P. Gadhe, Phoenix, AZ (US)

(21) Appl. No.: 18/800,142

(22) Filed: Aug. 12, 2024

(30) Foreign Application Priority Data
May 29, 2024 (IN) 202411041602

(51) Int. Cl. G06F 11/07

(52) U.S. Cl. CPC G06F 11/079; G06F 11/0709; G06F 11/2252; G06F 21/00

(57) ABSTRACT

A method and system for determining anomaly and fault in open platform communications (OPC) data is disclosed. Through the utilization of at least one processor, the method comprises receiving a historic data from one or more sources for a predefined time period, wherein the historic data corresponds to a historical open platform communications (OPC) data from the one or more sources and an input data from at least one OPC client; analyzing the historic data using artificial intelligence/machine learning (AI/ML) models to identify events in the historic data; identifying patterns associated with the identified events using the AI/ML models; identifying one or more root causes associated with each of the patterns using the AI/ML models; correlating the identified patterns with the identified one or more root causes; and predicting one or more anomalies and faults associated with historic data, based at least on the correlation.

### CROSS-REFERENCE TO RELATED APPLICATION

The present application is a US non-provisional patent application claims the benefit of Indian provisional patent application having application No. 202411041602 filed on May 29, 2024, which is hereby incorporated by reference in its entirety.

### TECHNOLOGICAL FIELD

The present disclosure relates to industrial internet of things (IoT) systems, and more particularly relates to a method and system for determining anomaly and fault in open platform communications (OPC) data.

### BACKGROUND

Open Platform Communication (OPC) is used extensively in industrial control systems (ICS) and industrial internet of things (IIoT) environment. OPC enables data exchange between multi-vendor devices like controller, programmable logic controller (PLC), remote terminal unit (RTU), etc., and control applications. Further, data collected from the multi-vendor devices is stored in a data historian. In the ICS or IIOT environment, where a number of processes, systems and equipment are operating together, the collected data is complex and the data historian is difficult to work with. There is limited to no analysis available for the data historian, with limited visualization capabilities, and performance issues may arise in the OPC while retrieving large amount of archived data from the data historian. Further, it is very difficult to correlate if the particular logged event or group of events from the data historian are causing a real incident or not, that requires attention. A real incident involves a genuine threat or disruption to industrial processes, while a not real incident pertains to events that do not pose actual risks but may still trigger alarms or alerts in the systems. Further, additional infrastructure and resources are required for analyzing the data historian. Further, issues like lack of internet activity, interoperability issue, resources like central processing unit (CPU), memory, input/output (I/O) constraints, additional component's installation etc. limit the analysis. It is to be noted that OPC addresses the challenge of data communication between the multi-vendor devices. However, in many cases, it is difficult to check if the data contains any anomaly. Also, it is difficult to find if, in the past, any series of events had taken place that can explain the root cause of an issue. Due to the nature of ICS/IIOT environment, type of technologies used for analysis may cause adverse effect on the critical production.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method for determining anomaly and fault in open platform communications (OPC) data is disclosed. The method comprises receiving, via at least one processor, a historic data from one or more sources for a predefined time period. The historic data corresponds to a historical open platform communications (OPC) data from the one or more sources and an input data from at least one OPC client. Further, the method comprises analyzing, via the at least one processor, the historic data using one or more artificial intelligence/machine learning (AI/ML) models to identify one or more events in the historic data. Further, the method comprises identifying, via the at least one processor, one or more patterns associated with the identified one or more events using the one or more AI/ML models. Further, the method comprises identifying, via the at least one processor, one or more root causes associated with each of the one or more patterns identified using the one or more AI/ML models. Further, the method comprises correlating, via the at least one processor, the identified one or more patterns with the identified one or more root causes. Thereafter, the method comprises predicting, via the at least one processor, one or more anomalies and faults associated with the historic data, based at least on the correlation.

In some embodiments, the one or more sources comprise at least one of a scale, a remote terminal unit (RTU), a distributed control system (DCS), a programmable logic controller (PLC), or an analyzer. In some embodiments, the predefined time period comprises at least one of day, time, season, months, or years.

In some embodiments, the historical OPC data comprise at least one of the one or more events, one or more error messages, one or more keywords, one or more log messages, associated with one or more zones. The input data comprises at least one of an input request from the OPC client corresponding to reading and/or writing the historical OPC data. In some embodiments, the one or more zones comprise at least one of a manufacturing plant, a power generation facility, an oil and gas refinery, a smart grid, and a transportation system of an industrial control system/Industrial Internet of Things (ICS/IIoT) environment.

In some embodiments, the method comprises training, via the at least one processor, the one or more AI/ML models using one or more AI/ML techniques, based at least on the received historic data. The one or more AI/ML techniques comprise at least one of a supervised learning, an unsupervised learning, a rule based AI model, a natural language processing (NLP) model, an AI keyword search, a random forest, an eXtreme Gradient Boosting (XGBoost), or an ensembling technique.

In some embodiments, the NLP model is configured to associate one or more log messages from the historic data with one or more issues associated with the one or more zones, based at least on the analysis of the historic data. The one or more issues comprise at least one of an unauthorized action, a resource access, a file modification, and a process creation.

In some embodiments, the one or more events comprise at least one of communication lost with controller, access to remote server, station failure, calibration error, calibration cleared, channel hardware failure, configuration changed, device firmware mismatch, firmware downgraded, device duplicate address, rogue node connected, over temperature alert, sensor alert, short circuit detected, abrupt shutdown, parameter access lock changed, or controller CPU 90 percent (%).

In some embodiments, the one or more patterns comprise at least one of too many login failure event, an unauthorized elevated privilege event, a firmware version changed/downgraded event, a device index change event, or an erase master boot records and clear logs, backup and restore service stopped event.

In some embodiments, the one or more root causes comprise at least one of an unauthorized access, a privilege escalation, an unauthorized user/attacker trying to take advantage of vulnerable firmware, a possibility of intrusion/malware attack, or an intrusion and possibility of ransomware trying to stop backup.

In some embodiments, the method further comprising storing, via the at least one processor, the correlated one or more patterns with the one or more root causes in a memory communicatively coupled to the at least one processor.

In another example embodiment, a system for determining anomaly and fault in open platform communications (OPC) data is disclosed. The system comprising a memory and at least one processor communicatively coupled to the memory. The at least one processor is configured to receive a historic data from one or more sources for a predefined time period. The historic data corresponds to a historical open platform communications (OPC) data from the one or more sources and an input data from at least one OPC client. Further, the at least one processor is configured to analyze the historic data using one or more artificial intelligence/machine learning (AI/ML) models to identify one or more events in the historic data. Further, the at least one processor is configured to identify one or more patterns associated with the identified one or more events using the one or more AI/ML models. Further, the at least one processor is configured to identify one or more root causes associated with each of the one or more patterns identified using the one or more AI/ML models. Further, the at least one processor is configured to correlate the identified one or more patterns with the identified one or more root causes. Thereafter, the at least one processor is configured to predict one or more anomalies and faults associated with the historic data, based at least on the correlation.

In yet another example embodiment, a non-transitory machine-readable information storage medium for determining anomaly and fault in open platform communications (OPC) data is disclosed. The non-transitory machine-readable information storage medium comprising one or more instructions which when executed by at least one processor cause the at least one processor to receive a historic data from one or more sources for a predefined time period, wherein the historic data corresponds to a historical open platform communications (OPC) data from the one or more sources and an input data from at least one OPC client; analyze the historic data using one or more artificial intelligence/machine learning (AI/ML) models to identify one or more events in the historic data; identify one or more patterns associated with the identified one or more events using the one or more AI/ML models; identify one or more root causes associated with each of the one or more patterns identified using the one or more AI/ML models; correlate the identified one or more patterns with the identified one or more root causes; and predict one or more anomalies and faults associated with the historic data, based at least on the correlation.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRA WINGS

Having thus described certain example embodiments of the present disclosure in general terms, reference will hereinafter be made to the accompanying drawings, which are not necessarily drawn to scale, and wherein:

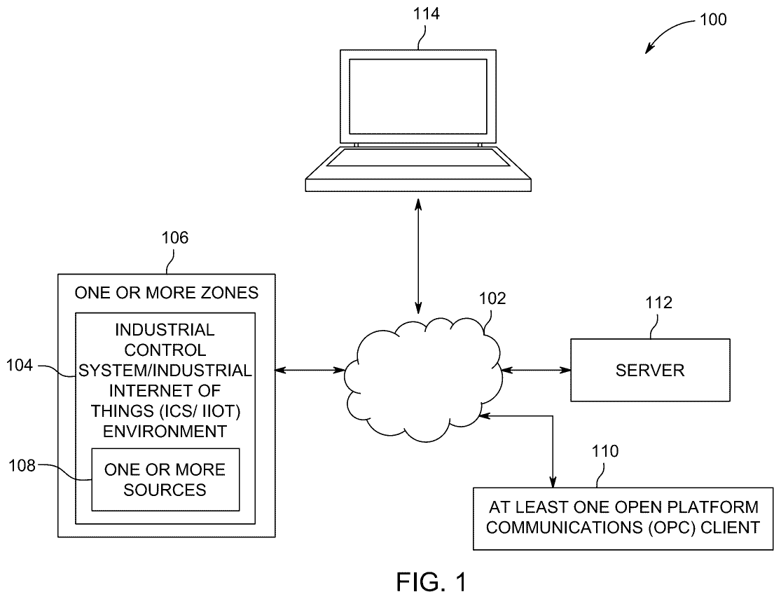

FIG. 1 illustrates a network diagram of a system for determining anomaly and fault in open platform communications (OPC) data in accordance with an example embodiment of the present disclosure;

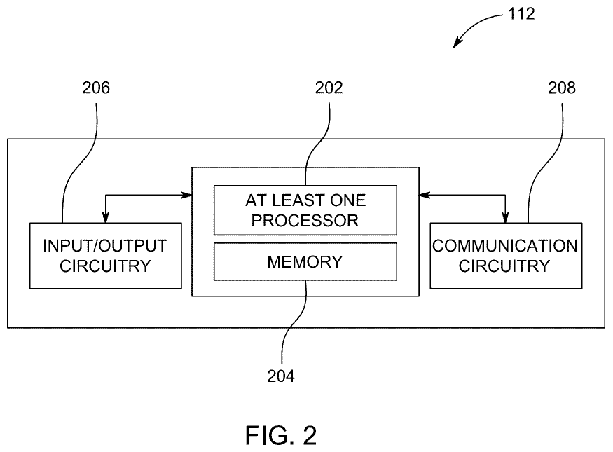

FIG. 2 illustrates a block diagram of a server in accordance with an example embodiment of the present disclosure;

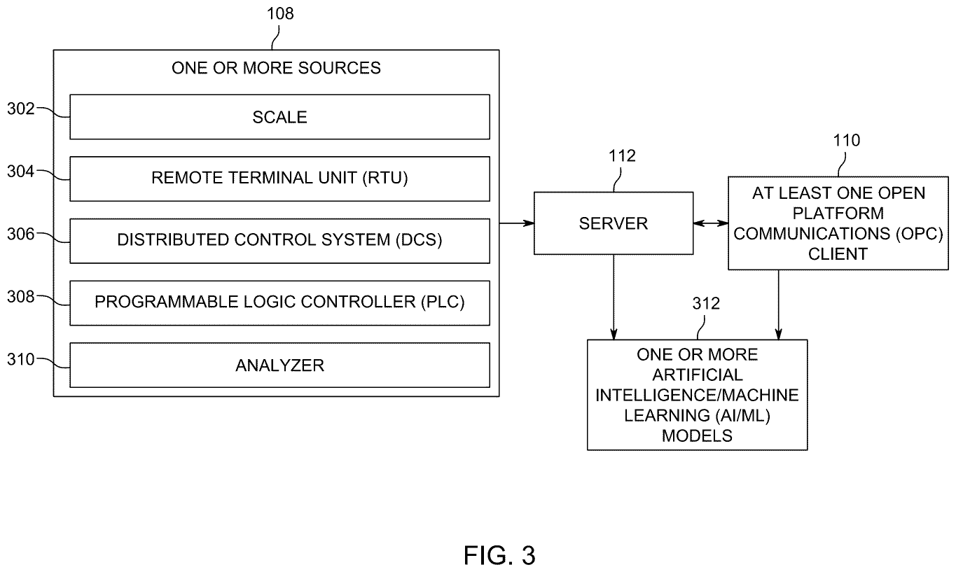

FIG. 3 illustrates one or more sources and at least one OPC client in communication with the server in accordance with an example embodiment of the present disclosure;

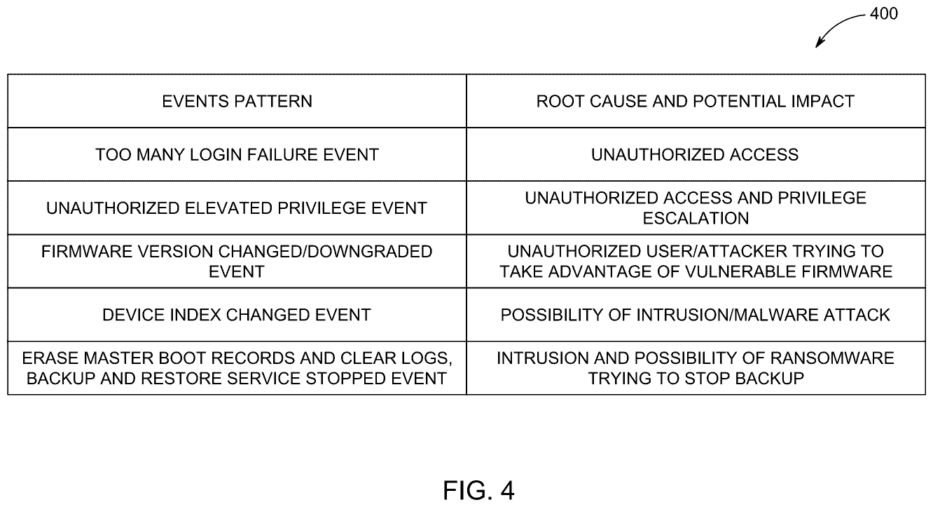

FIG. 4 illustrates at least one database having one or more patterns correlated with one or more root causes in accordance with an example embodiment of the present disclosure;

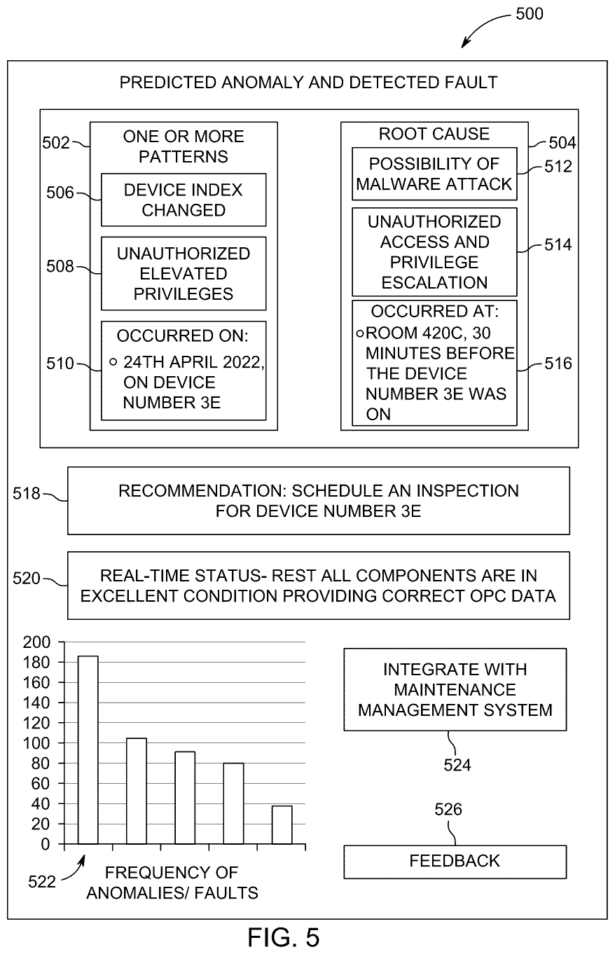

FIG. 5 illustrates an exemplary user interface (UI) of the system in accordance with an example embodiment of the present disclosure;

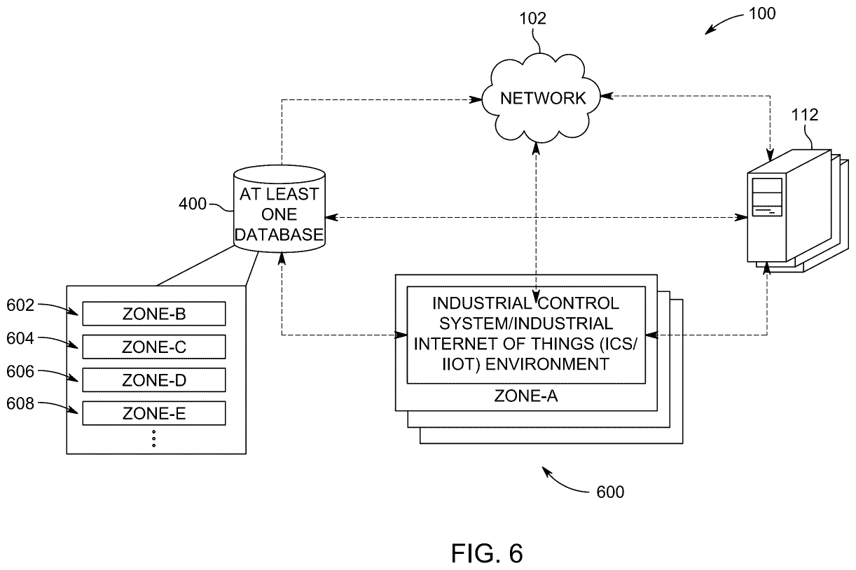

FIG. 6 illustrates a block diagram showing implementation of the system within one or more zones in accordance with an example embodiment of the present disclosure; and

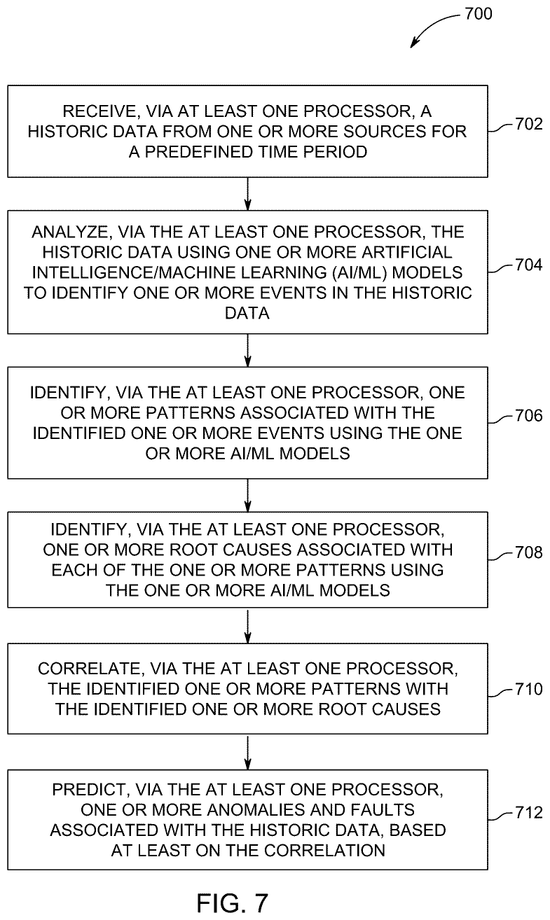

FIG. 7 illustrates a flowchart showing a method for determining the anomaly and fault in the OPC data in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to raise and lower objects unless otherwise noted.

The components illustrated in the figures represent components that may or may not be present in various embodiments of the disclosure described herein such that embodiments may include fewer or more components than those shown in the figures while not departing from the scope of the disclosure. Some components may be omitted from one or more figures or shown in dashed line for visibility of the underlying components.

The present disclosure provides various embodiments of methods and systems for determining anomaly and fault in open platform communications (OPC) data. Embodiments may be configured to be executed by at least one processor for determining anomaly and fault in the OPC data. Embodiments may be configured to receive a historic data from one or more sources for a predefined time period. The historic data may correspond to a historical OPC data from one or more sources and an input data from at least one OPC client. Embodiments may be configured to analyze the historic data using one or more artificial intelligence/machine learning (AI/ML) models to identify one or more events in the historic data. Embodiments may be configured to identify one or more patterns associated with the identified one or more events using the one or more AI/ML models. Embodiments may be configured to identify one or more root causes associated with each of the one or more patterns using the one or more AI/ML models. Embodiments may be configured to correlate the identified one or more patterns with the identified one or more root causes. Embodiments may be configured to predict one or more anomalies and faults associated with the historic data, based at least on the correlation.

FIG. 1 illustrates a network diagram of a system 100 for determining anomaly and fault in open platform communications (OPC) data, in accordance with an example embodiment of the present disclosure. The system 100 may comprise a network 102 communicatively coupled to an Industrial Control System/Industrial Internet of Things (ICS/IIoT) environment 104 of one or more zones 106, one or more sources 108, at least one open platform communications (OPC) client 110, a server 112, and a user device 114.

In some embodiments, the network 102 may be a communication network such as internet or a cloud network, that may be configured to allow computing devices and processing system to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

In some embodiments, the network 102 may be communicatively coupled to the ICS/IIoT environment 104. The ICS/IIoT environment 104 may be implemented in the one or more zones 106. In some embodiments, the one or more zones 106 may comprise at least one of a manufacturing plant, a power generation facility, an oil and gas refinery, a smart grid, and a transportation system of the ICS/IIOT environment 104. Further, the ICS/IIOT environment 104 may integrate physical machinery with networked sensors, actuators, and computing systems to monitor and manage industrial processes in the one or more zones 106 in real-time.

In the manufacturing plant, for instance, the ICS/IIoT environment 104 may enable efficient production by automating processes, optimizing workflows, and providing insights into equipment performance and resource utilization. By integrating sensors embedded in machinery, data may be collected on parameters like temperature, pressure, and speed, which is then transmitted to centralized control systems. Similarly, in power generation facilities, the ICS/IIoT environment 104 may be crucial for monitoring and controlling complex systems such as turbines, generators, and distribution networks. By integrating sensors, variables such as voltage, current, and frequency may be monitored continuously, allowing operators to maintain optimal operating conditions and respond swiftly to fluctuations in demand or supply.

In the oil and gas refineries, the ICS/IIoT environment 104 may play a critical role in ensuring safety, efficiency, and regulatory compliance. By integrating sensors, actuators, and control systems, various processes such as refining, blending, and distribution of petroleum products may be monitored and controlled. In the transportation systems, including smart grids and intelligent transportation networks, the ICS/IIOT environment 104 may enable efficient management of infrastructure and resources. In the smart grid, the ICS/IIoT environment 104 may comprise sensors installed in power lines, substations, and meters that provides real-time data on energy consumption, grid stability, and renewable energy integration. The real-time data may allow grid operators to balance supply and demand, manage peak loads, and improve overall grid resilience. In transportation systems, IIoT-enabled sensors and control systems may optimize traffic flow, enhance safety through predictive maintenance of vehicles and infrastructure, and enable real-time monitoring of fleet operations.

In some embodiments, the ICS/IIoT environment 104 may be configured to receive a historic data associated with the one or more zones 106 for a predefined time period. The predefined time period may correspond to historical time zone that comprises at least day, time, season, months, or years. The historic data may correspond to a historical OPC data from one or more sources 108 and an input data from at least one OPC client 110. Further, the historical OPC data may comprise one or more events, one or more error messages, one or more keywords, one or more log messages, associated with the one or more zones 106. The input data may comprise at least one of an input request from the OPC client corresponding to reading, and/or writing the historical OPC data. Furthermore, the one or more events may correspond to communication lost with controller, access to remote server, station failure, calibration error, calibration cleared, channel hardware failure, configuration changed, device firmware mismatch, firmware downgraded, device duplicate address, rogue node connected, over temperature alert, sensor alert, short circuit detected, abrupt shutdown, parameter access lock changed, or controller CPU 90 percent (%).

In some embodiments, the one or more sources 108 may be installed within the ICS/IIoT environment 104. The one or more sources 108 may be configured to provide the historical OPC data. The one or more sources 108 may comprise at least one of a scale, a remote terminal unit (RTU), a distributed control system (DCS), a programmable logic controller (PLC), or an analyzer. Further, the server 112 may be configured to receive the historic data from the one or more sources 108 and the at least one OPC client 110.

In some embodiments, the network 102 may be communicatively coupled to the at least one OPC client 110. The at least one OPC client 110 may correspond to a software application or device that communicates with the server 112 to access the historical data and a real-time data, as well as to control industrial automation systems in the ICS/IIoT environment 104. It is apparent to one skilled in the art that the OPC is a set of standards for interoperability in the ICS/IIoT environment 104, allowing the one or more sources 108 and software systems to exchange data seamlessly. In some embodiments, the at least one OPC client 110 may comprise supervisory control and data acquisition (SCADA) systems, human-machine interface (HMI) software, data historians, and custom-built applications. The at least one OPC client 110 may utilize OPC protocol to establish communication with the server 112 to retrieve historical data from the one or more sources 108. Further, the at least one OPC client 110 may utilize OPC protocol to establish communication with the server 112 to send commands for process control and monitoring purposes in the ICS/IIOT environment. In some embodiments, the at least one OPC client 110 may be configured to provide an input data. The input data may correspond to a request from the at least one OPC client 110.

In some embodiments, the ICS/IIoT environment 104 may be configured to provide the historic data to the server 112 in real time. Further, the server 112 may be configured to regulate operation of the ICS/IIOT environment to continuously receive the historic data from the one or more sources 108 and at least one OPC client 110. In some embodiments, the server 112 may be a computer or software module that is configured to provide centralized resources, data, or services to the user device 114 operated by a user. The server 112 may be configured to handle and manage one or more computational tasks and data processing within the system 100. In some embodiments, the server 112 may include storage systems, such as hard drives or storage arrays, to store and manage large volumes of data and information accessible to network users. In some embodiments, the server 112 may further provide centralized control and management capabilities, allowing network administrators to configure, monitor, and maintain network resources, security settings, and user access permissions from a single location. In some embodiments, the at least one OPC client 110 may be integrated within the ICS/IIoT environment 104.

In some embodiments, the server 112 may be configured to receive the historic data from the one or more sources 108 for a predefined time period. The historic data may correspond to the historical OPC data from one or more sources 108 and the input data from at least one OPC client 110. Further, the server 112 may be configured to analyze the historic data using one or more artificial intelligence/machine learning (AI/ML) models to identify one or more events in the historic data. Further, the server 112 may be configured to identify one or more patterns associated with the identified one or more events using the one or more AI/ML models. Further, the server 112 may be configured to identify one or more root causes associated with each of the one or more patterns using the one or more AI/ML models.

In some embodiments, the server 112 may be configured to correlate the identified one or more patterns and the identified one or more root causes. Thereafter, the server 112 may be configured to predict one or more anomalies and faults associated with the historic data, based at least on the correlation. The server 112 may be configured to evaluate a performance of the one or more sources within one or more zones, based at least on the analysis of the historic data. In some embodiments, the predicted one or more anomalies and faults, and the performance assessment by the server 112 may provide a summarized data to the user that is easy to understand and take action in case one or more events occurs in the ICS/IIoT environment 104. In some embodiments, the user device 114 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

FIG. 2 illustrates a block diagram of the server 112, in accordance with an example embodiment of the present disclosure. FIG. 2 is described in conjunction with FIG. 1.

In some embodiments, the server 112 may comprise at least one processor 202, a memory 204, an input/output circuitry 206, and a communication circuitry 208. In some embodiments, the at least one processor 202 may be configured to receive the historic data associated with the one or more zones 106 for a predefined time period. The historic data may correspond to the historical OPC data from one or more sources 108 and the input data from at least one OPC client 110. The historical OPC data may serve as a comprehensive record of past activities and occurrences within the one or more zones 106. The input data may interact directly with the historical OPC data, to influence or reflect changes in the ICS/IIoT environment 104 or triggering new events that need to be analyzed for predicting one or more anomalies and faults. The historic data may serve as a foundational dataset upon which the one or more AI/ML models are applied to the identify one or more patterns, identify one or more root causes, and predict one or more anomalies and faults within the ICS/IIOT environment 104.

In some embodiments, the one or more zones 106 may comprise at least one of the manufacturing plant, the power generation facility, the oil and gas refinery, the smart grid, and the transportation system of the ICS/IIOT environment. The predefined time period may correspond to historical time zone for which the historic data is received by the at least one processor 202. Further, the predefined time period may comprise at least day, time, season, months, or years. In one example, the at least one processor 202 receives the historic data for a predefined time period of two months. Further, the one or more sources 108 may comprise at least one of the scale, the RTU, the DCS, the PLC, or the analyzer, that are described later in detail in conjunction with FIG. 3.

In some embodiments, the historical OPC data may comprise the one or more events, one or more error messages, one or more keywords, one or more log messages, associated with the one or more zones 106. The one or more events may be triggered by various operations in the ICS/IIoT environment 104. The one or more error messages may indicate irregularities or failures in the ICS/IIoT environment 104. The one or more keywords may correspond to specific operations or conditions in the ICS/IIoT environment 104. The one or more log messages may provide insights into operational states and changes over time in the ICS/IIOT environment 104. In some embodiments, the input data may comprise at least one of the input request from the OPC client corresponding to reading, and/or writing the historical OPC data. For example, the at least one processor 202 receives a historic data from the DCS 306 installed in the ICS/IIOT environment 104.

In some embodiments, the at least one processor 202 may be configured to analyze the historic data using one or more trained AI/ML models. Further, the at least one processor may be configured to train the one or more AI/ML models using one or more AI/ML techniques, based at least on the received historic data. The one or more AI/ML techniques may comprise at least one of a supervised learning, an unsupervised learning, a rule based AI model, a natural language processing (NLP) model, an AI keyword search, a random forest, an eXtreme Gradient Boosting (XGBoost), or an ensembling technique. The NLP model may be configured to associate the one or more log messages from the historic data with one or more issues associated with the one or more zones 106, based at least on the analysis. The one or more issues may comprise at least one of an unauthorized action, a resource access, a file modification, and a process creation.

In one example, the supervised learning may be employed to analyze the historic data. Further, the supervised learning may classify the historical OPC data into one or more predefined categories, such as a normal event and an anomalous event, based on the previously labeled examples in the historic data. As part of supervised learning, all log events that relate to a real incident may be labelled so the one or more AI/ML model recognizes an event from one or more events or a pattern from one or more patterns, again if the one or more AI/ML models sees the same event or the pattern.

In another example, the unsupervised learning may aim to uncover hidden patterns or structures within the historic data, such as clustering similar events together or identifying outliers in the historical OPC data without previously labelled examples in the historic data. The unsupervised learning may be used in an instance in which the one or more AI/ML models determines the one or more patterns and correlations in a dataset, described later in detail in conjunction with FIG. 4, that can be used to predict one or more anomalies and faults.

In yet another example, the rule-based AI model may use predefined set of rules and a set of facts to make decisions or predictions. In rule-based AI model, analysis may occur on the historic data beforehand to determine what the exact logic in needed in order to predict one or more anomalies and faults based on the historic data. The rule-based AI model may be used to interpret specific conditions or thresholds in the historic data to determine anomalies or faults based on the predefined set of rules and the set of facts.

In another example, the AI keyword search may involve searching for specific keywords or phrases from the one or more keywords within the historic data that are indicative of anomalous behavior or fault states. The AI keyword search may correspond to a broader text mining approach to extract relevant information from the historic data. In yet another example, the random forest may correspond to an ensemble learning method that constructs multiple decision trees during training and outputs the mode of the classes (classification) or the mean prediction (regression) of the individual trees in the historic data. The random forest may be effective for classification tasks and handle large datasets with high dimensionality to analyze the complex historic data comprising the historical OPC data and the input data.

In another example, the XGBoost may correspond to an ensemble learning technique that sequentially builds trees, based on the historic data, and minimizes errors by learning from mistakes in the built trees. The XGBoost may be effective for both classification and regression task in the historic data to predict one or more anomalies and faults associated with the historic data. In yet another example, the ensembling technique may involve combining the supervised learning, the unsupervised learning, the rule based AI model, the NLP model, the AI keyword search, the random forest, the XGBoost, or any combination thereof, to improve the prediction of the one or more anomalies and faults associated with the historic data. By aggregating predictions from the one or more AI/ML models, the ensembling may achieve results better than each of the one or more AI/ML models, individually. The ensembling may enhance the accuracy and robustness of predicting the one or more anomalies and faults associated with the historic data.

Further, the at least one processor 202 may be configured to identify the one or more events in the historic data, based at least on the analysis for the predefined time period. The one or more events may correspond to communication lost with controller, access to remote server, station failure, calibration error, calibration cleared, channel hardware failure, configuration changed, device firmware mismatch, firmware downgraded, device duplicate address, rogue node connected, over temperature alert, sensor alert, short circuit detected, abrupt shutdown, parameter access lock changed, or controller CPU 90 percent (%).

In an exemplary embodiment, the “communication lost with controller” event may occur in an instance in which there is a disruption in communication between the system's controller and the one or more sources 108. The “communication lost with controller” event may occur due to various reasons such as network issues, hardware failures, or software glitches. The “communication lost with controller” event may lead to disruptions in data exchange, control signals, and monitoring capabilities, potentially impacting the overall operational efficiency and safety of the system 100 using the OPC. In another exemplary embodiment, the “access to remote server” event may signify successful access to a remote server from within the ICS/IIoT environment 104. The “access to remote server” event may indicate that the system 100 is able to establish a connection with a remote server for data exchange, software updates, or other purposes. The “access to remote server” event monitoring may be crucial for tasks such as remote monitoring, maintenance, and troubleshooting, enabling efficient management of industrial processes across distributed locations in the ICS/IIOT environment 104 using the OPC.

In yet another exemplary embodiment, the “station failure” event may indicate a malfunction or a failure of a station within the ICS/IIOT environment 104. Station may refer to individual devices, subsystems, or nodes responsible for specific tasks or functions within the system 100. The “station failure” event may disrupt normal operations in the ICS/IIoT environment 104. The “station failure” event may require prompt intervention to restore functionality and prevent further complications in the ICS/IIoT environment 104 using the OPC. In another exemplary embodiment, “calibration error” event may occur in an instance in which there is an error or discrepancy detected during the calibration process of sensors or instruments within the ICS/IIOT environment 104. The “calibration error” event may result from factors such as equipment drift, environmental changes, or improper calibration procedures. Addressing “calibration error” event promptly may be crucial to ensure the accuracy and reliability of measurement data used for control and decision-making purposes in the ICS/IIOT environment 104 using the OPC.

In yet another exemplary embodiment, “calibration cleared” event may indicate a successful clearing or resolution of a previously detected calibration error within the ICS/IIoT environment 104. The “calibration cleared” event may signify that a corrective action has been taken to rectify the calibration issue, restoring the accuracy and integrity of sensor or instrument readings. Clearing calibration errors promptly may help to maintain the reliability and consistency of data used for process control and monitoring in the ICS/IIOT environment 104 using the OPC. In another exemplary embodiment, “channel hardware failure” event may indicate a failure or malfunction of hardware components associated with data channels within the ICS/IIoT environment 104. Data channels may facilitate the transmission of sensor data, control signals, and other communication protocols between devices. Hardware failures in data channels may disrupt data exchange in the ICS/IIoT environment 104, leading to operational inefficiencies and potential safety risks if not addressed promptly in the ICS/IIoT environment 104 using the OPC.

In yet another exemplary embodiment, “configuration changed” event may indicate that a configuration setting or parameter within the ICS/IIoT environment 104 is modified or updated. The “configuration change” event may impact behavior, functionality, and performance of the system 100, necessitating careful monitoring and documentation to ensure proper operation and compliance with operational requirements and standards in the ICS/IIoT environment 104 using the OPC. In another exemplary embodiment, “device firmware mismatch” event may occur in an instance on which there is an inconsistency or mismatch between firmware versions of interconnected devices within the ICS/IIoT environment 104. The “device firmware mismatch” event may lead to compatibility issues, communication errors, and system instability that highlights the importance of maintaining uniform firmware versions across interconnected devices to ensure seamless operation and interoperability in the ICS/IIoT environment 104 using the OPC.

In yet another exemplary embodiment, “firmware downgraded” event may indicate that a firmware version of a device within the ICS/IIOT environment 104 is intentionally or unintentionally reverted to an older or previous version. The “firmware downgraded” event may occur for various reasons such as compatibility issues, bug fixes, or troubleshooting attempts. However, downgrading firmware versions may be performed cautiously to avoid potential compatibility issues and security vulnerabilities in the ICS/IIOT environment 104 using the OPC. In another exemplary embodiment, “device duplicate address” event may signify detection of duplicate network addresses assigned to devices within the ICS/IIOT environment 104. The “device duplicate address” event may cause network 102 conflicts, communication errors, and disruptions in data exchange between the devices. Resolving “device duplicate address” event may require reassigning unique network addresses to affected devices to ensure proper network functionality and data integrity in the ICS/IIOT environment 104 using the OPC.

In yet another exemplary embodiment, “rogue node connected” event may indicate detection of an unauthorized or unauthenticated device connected to a network within the ICS/IIoT environment 104. Rogue nodes may pose security risks and potential threats to the integrity and confidentiality of data, as the rogue nodes may attempt to gain unauthorized access, manipulate system settings, or disrupt normal operations. The “rogue node connected” event may be promptly identified and isolated to safeguard the network and prevent security breaches in the ICS/IIoT environment 104 using the OPC. In another exemplary embodiment, “over temperature alert” event may occur when temperature of a component or the one or more zones 106 within the ICS/IIoT environment 104 exceeds a predefined threshold or safety limits. The “over temperature alert” event may indicate potential overheating issues, that may lead to equipment damage, malfunctions, or safety hazards if not addressed promptly. Monitoring and responding to “over temperature alert” event may be monitored and responded timely for preventing equipment failures, maintaining operational reliability, and ensuring personnel safety in the ICS/IIoT environment 104 using the OPC.

In yet another exemplary embodiment “sensor alert” event may indicate detection of abnormal or out-of-range readings from sensors within the ICS/IIoT environment 104. The “sensor alert” event may indicate various issues such as equipment malfunctions, process deviations, or environmental changes that may require attention or corrective action. The “sensor alert” event may be promptly responded for maintaining the accuracy and reliability of data used for process control, monitoring, and decision-making purposes in the ICS/IIoT environment 104 using the OPC. In another exemplary embodiment, “short circuit detected” event may indicate detection of a short circuit condition within electrical circuits or components of the ICS/IIoT environment 104. Short circuits may result in electrical failures, equipment damage, and safety hazards such as fire or electric shock. Detecting short circuits promptly may allow for timely intervention to isolate the fault, prevent further damage, and restore normal operation of the system 100 in the ICS/IIoT environment 104 using the OPC.

In yet another exemplary embodiment, “abrupt shutdown” event may indicate a sudden and unexpected cessation of operations or functions within the ICS/IIoT environment 104. The “abrupt shutdown” event may occur due to various reasons such as equipment failures, power outages, or emergency shutdown procedures. The “abrupt shutdown” event may disrupt production, endanger personnel safety. The “abrupt shutdown” event may cause financial losses, underscoring the importance of implementing preventive measures and contingency plans to minimize downtime and mitigate risks in ICS/IIoT environment 104 using the OPC. In another exemplary embodiment, “parameter access lock changed” event may indicate a change in the access lock status of parameters within the ICS/IIOT environment 104. Parameter access locks may correspond to security measures implemented to control access to critical system settings and configurations. Changes in parameter access locks may signify modifications to system permissions, user privileges, or security policies. The “parameter access lock changed” event may require careful monitoring and auditing to maintain system integrity and prevent unauthorized access or tampering in ICS/IIoT environment 104 using the OPC data.

In yet another exemplary embodiment, “controller CPU 90%” event may occur in an instance in which the CPU utilization of a controller within the ICS/IIOT environment 104 reaches or exceeds 90%. High CPU utilization may indicate resource constraints, processing bottlenecks, or excessive system load, potentially impacting system responsiveness and performance. CPU utilization level may be monitored to identify potential performance issues and optimize system resource allocation to ensure smooth operation and stability in ICS/IIoT environment 104 using the OPC.

For example, the at least one processor 202 analyzes the historic data to identify a device firmware mismatch event and a firmware downgraded event using the NLP model.

In some embodiments, the at least one processor 202 may be configured to identify one or more patterns associated with the identified one or more events using the one or more AI/ML models. The at least one processor 202 may be configured to identify one or more patterns based at least on the analyzed historic data. The one or more patterns may comprise at least one of a too many login failure event, an unauthorized elevated privilege event, a firmware version changed/downgraded event, a device index change event, or an erase master boot records and clear logs, backup and restore service stopped event.

In an exemplary embodiment, the “too many login failure event” pattern may indicate a series of unsuccessful login attempts within a specific timeframe or from a particular source. The “too many login failure event” pattern may suggest potential security threats such as brute-force attacks or unauthorized access attempts to the server 112 in the ICS/IIOT environment 104. The one or more AI/ML models may identify the “too many login failure event” pattern by analyzing the frequency, timing, and source IP addresses associated with the “too many login failure event” pattern, helping to identify anomalous login behaviors that may require further investigation or intervention.

In another exemplary embodiment, the “unauthorized elevated privilege event” pattern may involve an instance where user privileges or access rights are elevated without proper authorization. The “unauthorized elevated privilege event” pattern may indicate a security breach or insider threat scenario within the ICS/IIOT environment 104, where another user gains unauthorized access to privileged operations or the OPC data. The one or more AI/ML models may identify the “unauthorized elevated privilege event” pattern by monitoring changes in user permissions, access logs, or system configurations, alerting administrators to potential security risks and enforcing access control policies to prevent unauthorized privilege escalation.

In yet another exemplary embodiment, the “firmware version changed/downgraded event” pattern may correspond to changes or downgrades in the firmware version of devices within the server 112 in the ICS/IIoT environment 104. The “firmware version changed/downgraded event” pattern may impact compatibility, performance, or security vulnerabilities in the OPC data associated with the ICS/IIOT environment 104. The one or more AI/ML models may analyze the historic data to identify the firmware version changed/downgraded event” pattern across one or more sources 108 associated with the ICS/IIoT environment 104, to flag discrepancies or unauthorized changes that may compromise integrity or functionality of the ICS/IIoT environment 104. Timely detection of the firmware version changed/downgraded event” pattern may allow administrators to verify changes, assess the impact of changes, and mitigate potential risks associated with incompatible or compromised firmware versions.

In another exemplary embodiment, the “device index change event” pattern may involve alterations in the indexing or identification of one or more sources, within the ICS/IIoT environment 104, exchanging the OPC data. The “device index change event” pattern may affect data routing, communication protocols, or system integration, potentially leading to operational disruptions or data integrity issues. The one or more AI/ML models may monitor the historic data to identify the “device index change event” pattern, highlighting anomalies or inconsistencies that may require corrective actions or system reconfiguration to maintain seamless operation and data consistency.

In yet another exemplary embodiment, the “erase master boot records and clear logs, backup and restore service stopped event” pattern may signify critical events such as the erasure of master boot records (MBR), clearing of logs, or the unexpected termination of backup and restore services within the ICS/IIOT environment that is exchanging the OPC data. The “erase master boot records and clear logs, backup and restore service stopped event” pattern may indicate malicious activities aimed at covering tracks, data loss incidents, or disruptions in data protection mechanisms. The one or more AI/ML models may analyze the historic data to identify the “erase master boot records and clear logs, backup and restore service stopped event” pattern to enable proactive detection of security breaches, operational failures, or compliance violations. Early detection of the “erase master boot records and clear logs, backup and restore service stopped event” pattern may allow prompt response measures to mitigate risks, restore system integrity, and ensure continuity of operations in the ICs/IIoT environment 104.

In some embodiments, the at least one processor 202 may be configured to identify one or more root causes associated with each of the one or more patterns using the one or more AI/ML models. Further, the one or more root causes may comprise at least one an unauthorized access, a privilege escalation, an unauthorized user/attacker trying to take advantage of vulnerable firmware, a possibility of intrusion/malware attack, or an intrusion and possibility of ransomware trying to stop backup. In an exemplary embodiment, the “unauthorized access” root cause may involve an instance where an unauthorized user gains access to the historic data without proper authorization. The “unauthorized access” root cause may occur through various means, such as exploiting vulnerabilities, using stolen credentials, or bypassing authentication mechanisms. The one or more AI/ML models may analyze the one or more patterns in the historic data to identify unauthorized access attempts or breaches, identifying anomalous behaviors that indicate potential security threats. By pinpointing the unauthorized access as a root cause, stricter access controls may be implemented to strengthen authentication mechanisms, and conduct regular security audits to prevent unauthorized entry into the historic data.

In another exemplary embodiment, the “privilege escalation” root cause may occur when an attacker or an unauthorized user gains elevated privileges within the system 100 beyond the authorized level. The “privilege escalation” root cause may allow the unauthorized user to perform actions reserved for administrators or privileged users, potentially compromising system integrity or accessing sensitive data. AI/ML models analyze historical OPC data to identify patterns indicative of privilege escalation, such as unauthorized changes in user permissions or access rights. Detecting privilege escalation as a root cause enables organizations to enforce least privilege principles, monitor privileged accounts closely, and implement mechanisms to prevent unauthorized elevation of privileges, thereby reducing the risk of insider threats or malicious activities.

In yet another exemplary embodiment, the “unauthorized user/attacker exploiting vulnerable firmware” root cause may correspond to scenarios where the attacker or the unauthorized user attacker exploits vulnerabilities in firmware within the system in the ICS/IIoT environment. The firmware vulnerabilities may be exploited to gain unauthorized access, manipulate device behavior, or disrupt operations of the system 100. The one or more AI/ML models may analyze the historic data to identify the “unauthorized user/attacker exploiting vulnerable firmware” root cause, such as unusual firmware updates or changes. Identifying the “unauthorized user/attacker exploiting vulnerable firmware” root cause may prompt the user to regularly update firmware, apply security patches promptly, and conduct vulnerability assessments to mitigate risks associated with vulnerable firmware and protect against potential exploits.

In another exemplary embodiment, the “possibility of intrusion/malware attack” root cause may indicate the likelihood of an intrusion attempt or malware attack targeting the system 100 exchanging the OPC data. Intrusion attempt or malware attack may lead to data breaches, system compromise, or operational disruptions. The one or more AI/ML models may analyze the historic data to identify the one or more patterns indicative of the “possibility of intrusion/malware attack” root cause, such as unusual network traffic patterns or unauthorized system accesses. Detecting the “possibility of intrusion/malware attack” root cause may prompt the user to enhance network security measures, deploy intrusion detection systems, conduct regular malware scans, and educate other users about phishing and social engineering threats to mitigate the risk of intrusions and malware attacks.

In yet another exemplary embodiment, the “intrusion and possibility of ransomware trying to stop backup” root cause may correspond to an instance where an intrusion occurs with the intent to deploy a ransomware attack that targets and disrupts backup and restore operations within the ICS/IIoT environment 104. Ransomware attack may encrypt critical data or system backups, rendering the encrypted critical data or the system backups inaccessible until a ransom is paid. The one or more AI/ML models may analyze the historic data to identify the one or more patterns indicative of the “possibility of intrusion/malware attack” root cause, such as sudden backups being stopped or encrypted files within the system. Detecting the “possibility of intrusion/malware attack” root cause may prompt the user to implement robust backup strategies, employ ransomware detection tools, segment networks to limit ransomware spread, and educate other users about ransomware prevention measures to mitigate the impact of ransomware attacks.

For example, the at least one processor 202 identifies a pattern of the firmware version changed/downgraded event and a root cause that the unauthorized user/attacker trying to take advantage of vulnerable firmware, based on the firmware mismatch event and the firmware downgraded event.

In some embodiments, the at least one processor 202 may be configured to correlate the identified one or more patterns and the identified one or more root causes. The at least one processor 202 may be configured to create the at least one database comprising the one or more patterns correlated with the one or more root causes. The at least one database may be described in detail in conjunction with the FIG. 4 in the detailed description. For example, the at least one processor 202 correlates the pattern of the firmware version changed/downgraded event and the root cause that the unauthorized user/attacker trying to take advantage of vulnerable firmware.

Further, the at least one processor 202 may be configured to predict the one or more anomalies and faults associated with the historic data, based at least on the correlation. Further, the performance evaluation may be performed based at least on the analysis of the historic data and the prediction. For example, the at least one processor 202 predicts whether the firmware mismatch event and the firmware downgraded event is happening and requires attention or not.

The at least one processor 202 may include suitable logic, circuitry, and/or interfaces that are operable to execute one or more instructions stored in the memory 204 to perform predetermined operations. In one embodiment, the at least one processor 202 may be configured to decode and execute any instructions received from one or more other electronic devices or server(s). The at least one processor 202 may be configured to execute one or more computer-readable program instructions, such as program instructions to carry out any of the functions described in this description. Examples of the at least one processor 202 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 204 may be configured to store a set of instructions and data executed by the at least one processor 202. Further, the memory 204 may include the one or more instructions that are executable by the at least one processor 202 to perform specific operations. The memory 204 may be configured to include the instructions to receive the set of parameters associated with the one or more zones 106 in the real time. The memory 204 may be configured to include the instructions to receive the historic data associated with the one or more zones 106 for the predefined time period. Further, the memory 204 may be configured to include the instructions to analyze the historic data using one or more trained AI/ML models. The memory 204 may be configured to include the instructions to identify one or more events in the historic data, based at least on the analysis for the predefined time period. The memory 204 may be configured to include the instructions to identify the one or more patterns associated with the one or more events, and the one or more root causes associated with each of the one or more events using the one or more AI/ML models, based at least on the analyzed historic data. The memory 204 may be configured to include the instructions to correlate the one or more patterns and the one or more root causes.

Further, the memory 204 may be configured to include the instructions to create at least one database comprising the one or more patterns correlated with the one or more root causes. The memory 204 may be configured to include the instructions to predict one or more anomalies and faults associated with the historic data, based at least on the correlation. It is apparent to a person with ordinary skill in the art that the one or more instructions stored in the memory 204 enable the hardware of the server 112 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 112 may further comprise the input/output circuitry 206. The input/output circuitry 206 may enable a user to communicate or interface with the server 112, via the user device 114. The user device 114 may include N number of user devices. In some embodiments, the input/output circuitry 206 may act as a medium to transmit input from the interface to and from the server 112 108. In some embodiments, the input/output circuitry 206 may refer to the hardware and software components that facilitate the exchange of information between the user device 114 and the server 112. The input/output circuitry 206 may include various input devices such as keyboards, barcode scanners, GUI for the one or more users to provide data and various output devices such as displays, printers for the one or more users to receive data. In another example, the input/output circuitry 206 may include various output circuitry such as a display to show the predicted one or more anomalies and faults with the performance assessment.

In some embodiments, the server 112 may further comprise the communication circuitry 208. The communication circuitry 208 may allow the server 112 to exchange data or information with other systems or apparatuses. Further, the communication circuitry 208 may include network interfaces, protocols, and software modules responsible for sending and receiving data or information. In some embodiments, the communication circuitry 208 may include Ethernet ports, Wi-Fi adapters, or communication protocols like HTTP or MQTT for connecting with other systems. The communication circuitry 208 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 208 may allow the server 112 to stay up-to-date and accurately track the predicted one or more anomalies and faults.

It will be apparent to one skilled in the art the above-mentioned components of the server 112 have been provided only for illustration purposes, without departing from the scope of the disclosure.

FIG. 3 illustrates the one or more sources 108 and the at least one OPC client 110 in communication with the server 112, in accordance with an example embodiment of the present disclosure. FIG. 3 is described in conjunction with FIGS. 1-2.

As illustrated in FIG. 2, the at least one processor 202 may be configured to receive the historic data associated with the one or more zones 106 for the predefined time period. The historic data may correspond to the historical OPC data from one or more sources 108 and the input data from at least one OPC client 110. In one example, the at least one OPC client may correspond to a software application or a component of the system 100 that interacts with the server 112 to exchange the input data. The at least one OPC client may request information from or send one or more commands to the server 112. In some embodiments, the one or more sources 108 may comprise at least one of a scale 302, a RTU 304, a DCS 306, a PLC 308, or an analyzer 310. In an exemplary embodiment, the scale 302 may correspond to a device commonly utilized for measuring weight or mass in the ICS/IIOT environment 104. The historical data from the scale 302 may comprise recorded weight or mass measurements over the predefined time period. To obtain historical data from the scale 302, a data acquisition system may be employed. The data acquisition system may periodically collect measurements from the scale 302. Further, the data acquisition system may store the historical data in a database. The server 112 may receive the historical data from the scale 302, via the OPC, with the data transmitted over the network 102. As a result, the server 112 may receive and analyze the historical data from the scale 302 for various purposes such as inventory management and quality control in the ICS/IIOT environment 104.

In another exemplary embodiment, the RTU 304 may correspond to a device utilized for remote monitoring and control of field devices and sensors across the ICS/IIOT environment 104. The historical data from the RTU 304 may comprises parameters such as temperature, pressure, and flow rates recorded over the predefined time period. Further, the historical data from the RTU 304 may be received by querying a memory of a device or data storage for logged values. The server 112 may receive the historical data from the RTU 304, via the OPC, enabling the transmission of data over the network 102 for storage and analysis in the ICS/IIoT environment 104.

In yet another exemplary embodiment, the DCS 306 may correspond to a centralized control system deployed in the ICS/IIOT environment 104 such as manufacturing and power generation. The historical data from the DCS 306 may comprise process variables, alarms, and one or more events logged over the predefined time period. The historical data may be acquired from the DCS 306 through a historian module of the DCS 306. The historian module may continuously log data at the predefined time period. Further, the server 112 may receive the historical data from the DCS 306, via the OPC, with the historical data transmitted over the network connection to be stored and analyzed for optimizing industrial processes in the ICS/IIOT environment 104.

In another exemplary embodiment, the PLC 308 may correspond to an industrial computer used for automating processes in the ICS/IIoT environment 104. The historical data from the PLC 308 may include inputs, outputs, and internal variables recorded during operation. Obtaining historical data from the PLC 308 may involve accessing a memory or one or more data registers of the PLC 308. Further, the server 112 may receive the historical data from the PLC 308, via the OPC, allowing for the transmission of the historical data over the network 102 for storage and analysis to enhance operational efficiency in the ICS/IIOT environment 104.

In yet another exemplary embodiment, the analyzer 310 may correspond to an instrument employed for measuring and analyzing chemical, physical, or biological properties in the ICS/IIoT environment 104. The historical data from the analyzer 310 may comprise measurements of specific parameters collected over the predefined time period. Obtaining the historical data from the analyzer 310 may involve querying a memory or a data storage of the analyzer 310 for logged values. Further, the server 112 may receive the historical data from the analyzer 310, via the OPC, enabling the transmission of the historical data over the network 102 for storage and analysis to ensure process optimization and compliance with regulatory standards in the ICS/IIoT environment 104.

In some embodiments, the at least one OPC client 110 may be configured to provide the input data. The input data may comprise at least one of the input request from the OPC client corresponding to reading, and/or writing the historical OPC data. The at least one OPC client 110 may provide the input data to the system 100. The input data may comprise requests related to reading or writing the historical OPC data, which consists of past records and events associated with one or more zones 106 within the system 100. The at least one OPC client 110 may facilitate communication between components of the system 100 and the server 112 to enable OPC data retrieval or modification based on operational needs or analytical requirements. The at least one OPC client 110 may facilitate data exchange and interaction with the historic data for various analytical purposes, including prediction of one or more anomalies and faults associated with the historic data. In one example embodiment, the request may be to read the historical data from the one or more sources 108. In another example embodiment, the request may be to write an additional data alongside the historical data from the one or more sources 108. In yet another embodiment, the request may be to write an additional data in the historical data from the one or more sources 108.

In some embodiments, the historic data may correspond to the historical OPC data from the one or more sources 108 and the input data from the at least one OPC client 110. Further, the at least one processor 202 may be configured to analyze the historical OPC data from the one or more sources 108 and the input data from the at least one OPC client 110 using one or more trained AI/ML models 312. Further, the at least one processor 202 may be configured to analyze the historic data to identify the one or more events in the historic data. Further, the at least one processor 202 may be configured to identify one or more patterns associated with the one or more events and the one or more root causes associated with each of the one or more events using the one or more AI/ML models 312, based at least on the analyzed historic data received from the one or more sources 108. Furthermore, the at least one processor 202 may be configured to correlate the one or more patterns and the one or more root causes. Thereafter, the at least one processor 202 may be configured to predict the one or more anomalies and faults associated with the historic data, based at least on the correlation.

FIG. 4 illustrates at least one database 400 having the one or more patterns correlated with one or more root causes, in accordance with an example embodiment of the present disclosure. FIG. 4 is described in conjunction with FIGS. 1-3.

As discussed in FIG. 2, the at least one processor 202 may be configured to create at least one database 400 comprising the one or more patterns correlated with the one or more root causes. The at least one database 400 may store the one or more patterns as “events pattern”. Further, the at least one database 400 may store the one or more root causes as “root cause and potential impact”. In one exemplary embodiment, the at least one database 400 may comprise the “too many login failure event” events pattern correlated with the at least one unauthorized access. The at least one database 400 may correlate the “too many login failure event” events pattern with the at least one unauthorized access, indicating that such login failures may be indicative of attempts by unauthorized user to gain entry into the system 100. By correlating the “too many login failure event” events pattern with the at least one unauthorized access, the at least database 400 may provide valuable insights for security monitoring and analysis. The correlation of the “too many login failure event” events pattern with the at least one unauthorized access, may help to identify potential security breaches, enabling users to take proactive measures such as enhancing authentication mechanisms, monitoring suspicious login activities, and implementing access controls to mitigate the risk of unauthorized access and strengthen overall system security.

In another exemplary embodiment, the at least one database 400 may comprise the “unauthorized elevated privilege event” events pattern correlated with the unauthorized access and the privilege escalation. The at least one database 400 may correlate the “unauthorized elevated privilege event” events pattern with the unauthorized access and the privilege escalation to indicate a potential progression from unauthorized user entry to gaining elevated privileges within the system 100. By correlating the “unauthorized elevated privilege event” events pattern with the unauthorized access and the privilege escalation, the at least one database 400 may provide comprehensive insights into security incidents that involve improper user access management. The correlation of the “unauthorized elevated privilege event” events pattern with the unauthorized access and the privilege escalation, may enable the users to identify and respond promptly to security breaches, enforce strict access controls, monitor privileged accounts rigorously, and implement measures to prevent unauthorized privilege escalation, thereby enhancing overall system security and integrity.

In yet another exemplary embodiment, the at least one database 400 may comprise the “firmware version changed/downgraded event” events pattern correlated with the unauthorized user/attacker trying to take advantage of vulnerable firmware. The at least one database 400 may correlate the “firmware version changed/downgraded event” events pattern with the unauthorized user/attacker trying to take advantage of vulnerable firmware to exploit vulnerabilities in the firmware, that may lead to security breaches, compromised system integrity, or unauthorized control over devices within the ICS/IIOT environment 104. By correlating the “firmware version changed/downgraded event” events pattern with the unauthorized user/attacker trying to take advantage of vulnerable firmware, the at least one database 400 may provide critical insights into potential security threats and vulnerabilities. The correlation of the “firmware version changed/downgraded event” events pattern with the unauthorized user/attacker trying to take advantage of vulnerable firmware, may allow the users to monitor firmware updates rigorously, apply security patches promptly, conduct vulnerability assessments regularly, and implement measures to safeguard against unauthorized firmware modifications, thereby enhancing overall system resilience and security posture.

In another exemplary embodiment, the at least one database 400 may comprise the “device index change event” events pattern correlated with the possibility of intrusion/malware attack. The at least one database 400 may correlate the “device index change event” events pattern with the possibility of intrusion/malware attack, indicating that changes in indexes of one or more sources may be indicative of unauthorized access attempts or malicious activities aimed at compromising system security. By correlating the “device index change event” events pattern with the possibility of intrusion/malware attack, the at least one database 400 may provide insights into potential security threats and vulnerabilities within the ICS/IIOT environment 104. The correlation of the “device index change event” events pattern with the possibility of intrusion/malware attack, may enable the users to monitor device configurations closely, detect unauthorized changes promptly, implement robust access controls, and deploy intrusion detection systems to mitigate risks associated with unauthorized access or malicious activities targeting device indexes, thereby enhancing the overall security posture of the system 100.

In yet another exemplar embodiment, the at least one database 400 may comprise the “erase master boot records and clear logs, backup and restore service stopped event” events pattern correlated with the intrusion and possibility of ransomware trying to stop backup. The at least one database 400 may correlate the “erase master boot records and clear logs, backup and restore service stopped event” events pattern with the intrusion and possibility of ransomware trying to stop backup to indicate that the ransomware can prevent users from accessing critical data backups, thereby increasing the likelihood of paying a ransom to regain access. By correlating the “erase master boot records and clear logs, backup and restore service stopped event” events pattern with the intrusion and possibility of ransomware trying to stop backup, the at least one database 400 may provide crucial insights into potential security breaches and ransomware attacks targeting system backup. The correlation of the “erase master boot records and clear logs, backup and restore service stopped event” events pattern with the intrusion and possibility of ransomware trying to stop backup may enable proactive measures such as enhancing backup security, implementing ransomware detection mechanisms, securing critical system components, and educating users about ransomware prevention strategies to mitigate risks and ensure business continuity in the face of cyber threats within the ICS/IIOT environment 104.

In some embodiments, the at least one database 400 may comprise one or more events correlated with one or more root causes apart from the one or more events correlated with the one or more root causes that are associated with the historic data, without departing from the scope of the disclosure. The at least one database 400 may encompass a broad range of one or more events and the correlations with the one or more root causes, all within the scope of the disclosure. The at least one database 400 may not only capture the one or more events that are primary and directly tied to the historic data and specific root causes associated with the one or more events that are primary, but also additional one or more events that may have different or overlapping one or more root causes. By incorporating correlations between additional one or more events with different or overlapping one or more root causes, the at least one database 400 may enhance the system's ability to detect, analyze, and respond effectively to various incidents and conditions affecting the OPC data, thereby contributing to improved system reliability, security, and performance management.

FIG. 5 illustrates an exemplary user interface (UI) 500 of the system 100, in accordance with an example embodiment of the present disclosure. FIG. 5 is described in conjunction with FIGS. 1-4.

In some embodiments, the UI 500 may display the predicted one or more anomalies and faults denoted as “PREDICTED ANOMALY AND DETECTED FAULT”. Further, the UI 500 may comprise one or more patterns block 502 and a root cause block 504. The one or more patterns block 502 may comprise a plurality of pattern text fields. The plurality of pattern text fields may display one or more patterns. In one exemplary embodiment, a first pattern text field 506 of the plurality of pattern text fields may display “device index changed”. Further, a second pattern text field 508 of the plurality of pattern text fields may display “unauthorized elevated privileges”. Furthermore, a third pattern text field 510 may display “occurred on: 24 Apr. 2022, on device number 3e”.

In some embodiments, the root cause block 504 may comprise a plurality of root cause text fields. The plurality of root cause text fields may display one or more root causes. In one exemplary embodiment, a first root cause text field 512 of the plurality of root cause text fields may display “possibility of malware attack”. Further, a second root cause text field 514 of the plurality of root cause text fields may display “unauthorized access and privilege escalation”. Furthermore, a third root cause text field 516 may display “occurred at: room 420c, 30 minutes before the device number 3e was on”.

In some embodiments, the UI 500 may comprise a recommendation text field 518. The alert text field 518 may display a recommendation based on the one or more patterns displayed on the one or more patterns block 502 and one or more root causes displayed on the root cause block 504. In one exemplary embodiment, the recommendation text field 518 may display “recommendation: schedule an inspection for device number 3e” Further, the UI 500 may comprise a real-time status text field 520. The real-time status text field 520 may display status of components of the ICS/IIoT environment 104 apart from the components of which the one or more patterns and the one or more root causes are displayed.

In some embodiments, the UI 500 may display a graph, as illustrated by 522. The graph 522 may display frequency of anomalies/faults of components for the predefined time period. The frequency of anomalies/faults may be displayed on x-axis of the graph. The predefined time period may be displayed on the y-axis of the graph. In some embodiments, the UI 500 may comprise an integrate with maintenance management system button 524. The integrate with maintenance management system button 524 may link directly to a maintenance management system in which one or more users may create work orders for scheduled inspections or repairs based on the recommendation by the recommendation text field 518.

Further, the UI 500 may comprise a feedback button 526. The feedback button 526 may direct one or more users to a feedback form. The feedback form may allow the one or more users to provide input on the accuracy of prediction of the one or more anomalies and faults. Further, the feedback form may provide options to suggest additional data sources or provide notes on maintenance outcomes for future improvement in the ICS/IIoT environment 104.

In some embodiments, the system 100 may be deployed on premise or in the cloud. Further, the system 100 may support OPC classic as well as OPC unified architecture (UA). It will be apparent to one skilled in the art that the UI 500 of the system 100 may comprise one or more components apart from the blocks, the text fields, or the buttons, without departing from the scope of the disclosure.

FIG. 6 illustrates a block diagram showing implementation of the system 100 within the one or more zones 106, in accordance with an example embodiment of the present disclosure. FIG. 6 is described in conjunction with FIGS. 1-5.

In some embodiments, the one or more zones 106 may comprise at least one of the manufacturing plant, the power generation facility, the oil and gas refinery, the smart grid, and the transportation system of the ICS/IIOT environment 104. Further, the one or more sources 108 may be installed within the one or more zones 106 of the ICS/IIOT environment 104. Further, the one or more sources 108 may correspond to the scale 302, the RTU 304, the DCS 306, the PLC 308, or the analyzer 310. In one example, the one or more sources 108 may be installed within a Zone-A 600. The Zone-A 600 may correspond to the power generation facility. Further, the ICS/IIoT environment 104 of the Zone-A 600 may be communicatively coupled with the server 112 and the network 102. Further, the server 112 may be configured to use the one or more AI/ML models 312 for identifying and correlating the one or more root causes and the one or more patterns that are associated with the one or more events of the Zone-A 600. Further, the one or more patterns correlated with the one or more root causes may be stored into the at least one database 400 by the server 112 via the network 102. Further, the at least one database 400 may be configured to store other identified and correlated one or more root causes associated with each of the one or more patterns that may be fed to the one or more AI/ML models 312 while using the one or more AI/ML models 312 to ensure that the one or more AI/ML models 312 may be updated and refined with new OPC data.

Further, the at least one database 400 may be coupled with another ICS/IIoT environment of another zone, i.e., Zone-B 602 through another server (not shown). Further, the Zone-B 602 may correspond to the smart grid. Further, the Zone-B 602 may comprise the another server to receive another historical OPC data, associated with the one or more sources 108 installed at the Zone-B 602. In some embodiments, the at least one database 400 stored with the correlated one or more root causes and the one or more patterns, and the one or more AI/ML models 312 may further be deployed into the another server of the Zone-B 602. The another server by using the deployed at least one database 400 may be configured to further identify and correlate one or more root causes and the one or more patterns that are associated with the one or more events of the Zone-B 602.

Further, the at least one database 400 may be coupled with another ICS/IIOT environment of another zone, i.e., Zone-C 604 through another server (not shown). Further, the Zone-C 604 may correspond to the manufacturing plant. Further, the Zone-C 604 may comprise the another server to receive another historical OPC data, associated with the one or more sources 108 installed at the Zone-C 604. In some embodiments, the at least one database 400 stored with the correlated one or more root causes and the one or more patterns, and the one or more AI/ML models 312 may further be deployed into the another server of the Zone-C 604. The another server by using the deployed at least one database 400 may be configured to further identify and correlate one or more root causes and the one or more patterns that are associated with the one or more events of the Zone-C 604.

Further, the at least one database 400 may be coupled with another ICS/IIoT environment of another zone, i.e., Zone-D 606 through another server (not shown). Further, the Zone-D 606 may correspond to the transportation system. Further, the Zone-D 606 may comprise the another server to receive another historical OPC data, associated with the one or more sources 108 installed at the Zone-D 606. In some embodiments, the at least one database 400 stored with the correlated one or more root causes and the one or more patterns, and the one or more AI/ML models 312 may further be deployed into the another server of the Zone-D 606. The another server by using the deployed at least one database 400 may be configured to further identify and correlate one or more root causes and the one or more patterns that are associated with the one or more events of the Zone-D 606.

Further, the at least one database 400 may be coupled with another ICS/IIOT environment of another zone, i.e., Zone-E 608 through another server (not shown). Further, the Zone-E 608 may correspond to the oil and gas refinery. Further, the Zone-E 608 may comprise the another server to receive another historical OPC data, associated with the one or more sources 108 installed at the Zone-E 608. In some embodiments, the at least one database 400 stored with the correlated one or more root causes and the one or more patterns, and the one or more AI/ML models 312 may further be deployed into the another server of the Zone-E 608. The another server by using the deployed at least one database 400 may be configured to further identify and correlate one or more root causes and the one or more patterns that are associated with the one or more events of the Zone-E 608.

FIG. 7 illustrates a flowchart showing a method 700 for determining the anomaly and fault by analyzing the OPC data, in accordance with an example embodiment of the present disclosure. FIG. 7 is described in conjunction with FIGS. 1-6.

At operation 702, the at least one processor 202 may be configured to receive the historic data from the one or more sources 108 for the predefined time period. The historic data may correspond to the historical OPC data from one or more sources 108 and the input data from the at least one OPC client 110. The one or more zones 106 may comprise at least one of the manufacturing plant, the power generation facility, the oil and gas refinery, the smart grid, and the transportation system of the ICS/IIOT environment. The predefined time period may correspond to historical time zone. The predefined time period may comprise at least day, time, season, months, or years. In some embodiments, the historical OPC data may comprise the one or more events, the one or more error messages, the one or more keywords, the one or more log messages, associated with the one or more zones 106. Further, the one or more sources 108 may comprise at least one of the scale 302, the RTU 304, the DCS 306, the PLC 308, or the analyzer 310. In some embodiments, the input data may comprise at least one of the input request from the OPC client corresponding to reading, and/or writing the historical OPC data.

For example, the at least one processor 202 receives a historic data from the DCS 306 installed in the ICS/IIOT environment 104.

At operation 704, the at least one processor 202 may be configured to analyze the historic data using one or more AI/ML models 312 to identify one or more events in the historic data. In some embodiments, the one or more events may correspond to communication lost with controller, access to remote server, station failure, calibration error, calibration cleared, channel hardware failure, configuration changed, device firmware mismatch, firmware downgraded, device duplicate address, rogue node connected, over temperature alert, sensor alert, short circuit detected, abrupt shutdown, parameter access lock changed, or controller CPU 90 percent (%).

In some embodiments, the at least one processor 202 may be configured to train the one or more AI/ML models 312 using one or more AI/ML techniques, based at least on the received historic data. The one or more AI/ML techniques may comprise at least one of the supervised learning, the unsupervised learning, the rule based AI model, the NLP model, the AI keyword search, the random forest, the XGBoost, or the ensembling technique. Further, the NLP model may be configured to associate the one or more log messages from the historic data with one or more issues associated with the one or more zones 106, based at least on the analysis. The one or more issues may comprise at least one of the unauthorized action, the resource access, the file modification, and the process creation.

For example, the at least one processor 202 analyzes the historic data to identify a device firmware mismatch event and a firmware downgraded event using the NLP model.

At operation 706, the at least one processor 202 may be configured to identify the one or more patterns associated with the identified one or more events using the one or more AI/ML models 312, based at least on the analyzed historic data. At operation 708, the at least one processor 202 may be configured to identify one or more root causes associated with each of the one or more patterns using the one or more AI/ML models 312. In some embodiments, the one or more patterns may comprise at least one of the too many login failure event, the unauthorized elevated privilege event, the firmware version changed/downgraded event, the device index change event, or the erase master boot records and clear logs, backup and restore service stopped event. In some embodiments, the one or more root causes comprises at least one the unauthorized access, the privilege escalation, the unauthorized user/attacker trying to take advantage of vulnerable firmware, the possibility of intrusion/malware attack, or the intrusion and possibility of ransomware trying to stop backup.

For example, the at least one processor 202 identifies a pattern of the firmware version changed/downgraded event and a root cause that the unauthorized user/attacker trying to take advantage of vulnerable firmware, based on the firmware mismatch event and the firmware downgraded event.

At operation 710, the at least one processor 202 may be configured to correlate the identified one or more patterns with the identified one or more root causes. Further, the at least one processor 202 may be configured to create the at least one database 400 comprising the one or more patterns correlated with the one or more root cause. For example, the at least one processor 202 correlates the pattern of the firmware version changed/downgraded event and the root cause that the unauthorized user/attacker trying to take advantage of vulnerable firmware.

At operation 712, the at least one processor 202 may be configured to predict the one or more anomalies and faults associated with the historic data, based at least on the correlation. Further, the performance of the one or more sources may be evaluated based at least on the analysis of the historic data and the prediction. For example, the at least one processor 202 predicts whether the firmware mismatch event and the firmware downgraded event is happening and requires attention or not.

In the present disclosure, the incorporation of historic data from the one or more sources and the at least one OPC client may enables a holistic understanding of system behavior over time, facilitating more accurate anomaly detection. Use of data centric approach where advanced analytics is done using AI/ML to uncover event patterns, performance degradation trends, and faults that may not be immediately apparent from the historic data. Further, leveraging one or more trained AI/ML models may enhance the precision and speed of data analysis, leading to quicker identification of events and patterns. With the capability to identify one or more root causes associated with the identified one or more events may foster proactive problem-solving, mitigating faults before the faults escalate. In the system, correlating one or more patterns and one or more root causes may aid in establishing causal relationships between pattern and root causes, enabling more targeted interventions and preventing recurrence of faults. Further, the creation of databases having correlated one or more patterns and one or more root causes may ensure easy access to insights for ongoing optimization and learning. The system providing predictive capabilities based on the correlation may empower preemptive action against potential anomalies and faults, boosting reliability and performance of the system. Additionally, performance evaluations based on thorough analysis and prediction may foster continuous improvement, refining the effectiveness of the system over time.

Further, the present disclosure proposes use of AI/ML to analyze a large volume of historical OPC data that is difficult for human operator to monitor or analyze and make decisions. Also, the analysis of historical OPC data may help to uncover root causes of some of the failures. The present disclosure may help to discover potential breaches in the past and stop future subsequent attacks. The present disclosure, while solving one problem, may also provide a foundation for data analytics in other facets related to data. Additionally, data collected may be used for analytics and to improve user experience.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via at least one processor, a historic data from one or more sources for a predefined time period, wherein the historic data corresponds to a historical open platform communications (OPC) data from the one or more sources and an input data from at least one OPC client;
analyzing, via the at least one processor, the historic data using one or more artificial intelligence/machine learning (AI/ML) models to identify one or more events in the historic data;
identifying, via the at least one processor, one or more patterns associated with the identified one or more events using the one or more AI/ML models;
identifying, via the at least one processor, one or more root causes associated with each of the one or more patterns identified using the one or more AI/ML models;
correlating, via the at least one processor, the identified one or more patterns with the identified one or more root causes; and
predicting, via the at least one processor, one or more anomalies and faults associated with the historic data, based at least on the correlation.

2. The method of claim 1, wherein the one or more sources comprise at least one of a scale, a remote terminal unit (RTU), a distributed control system (DCS), a programmable logic controller (PLC), or an analyzer.

3. The method of claim 1, wherein the predefined time period comprises at least one of a day, time, season, months, or years.

4. The method of claim 1, wherein the historical OPC data comprise at least one of the one or more events, one or more error messages, one or more keywords, one or more log messages, associated with one or more zones, and wherein the input data comprises at least one of an input request from the OPC client corresponding to reading and/or writing the historical OPC data.

5. The method of claim 4, wherein the one or more zones comprise at least one of a manufacturing plant, a power generation facility, an oil and gas refinery, a smart grid, or a transportation system of an industrial control system/Industrial Internet of Things (ICS/IIOT) environment.

6. The method of claim 4 further comprising training, via the at least one processor, the one or more AI/ML models using one or more AI/ML techniques, based at least on the received historic data, wherein the one or more AI/ML techniques comprise at least one of a supervised learning, an unsupervised learning, a rule based AI model, a natural language processing (NLP) model, an AI keyword search, a random forest, an extreme Gradient Boosting (XGBoost), or an ensembling technique.

7. The method of claim 6, wherein the NLP model is configured to associate one or more log messages from the historic data with one or more issues associated with the one or more zones based at least on the analysis of the historic data, wherein the one or more issues comprise at least one of an unauthorized action, a resource access, a file modification, and a process creation.

8. The method of claim 1, wherein the one or more events comprise at least one of communication lost with controller, access to remote server, station failure, calibration error, calibration cleared, channel hardware failure, configuration changed, device firmware mismatch, firmware downgraded, device duplicate address, rogue node connected, over temperature alert, sensor alert, short circuit detected, abrupt shutdown, parameter access lock changed, or controller CPU 90 percent (%).

9. The method of claim 1, wherein the one or more patterns comprise at least one of too many login failure event, an unauthorized elevated privilege event, a firmware version changed/downgraded event, a device index change event, or an erase master boot records and clear logs, backup and restore service stopped event.

10. The method of claim 1, wherein the one or more root causes comprise at least one of an unauthorized access, a privilege escalation, an unauthorized user/attacker trying to take advantage of vulnerable firmware, a possibility of intrusion/malware attack, or an intrusion and possibility of ransomware trying to stop backup.

11. The method of claim 1 further comprising storing, via the at least one processor, the correlated one or more patterns with the one or more root causes in a memory communicatively coupled to the at least one processor.

12. A system comprising:
a memory; and
at least one processor communicatively coupled to the memory, wherein the at least one processor is configured to:
receive a historic data from one or more sources for a predefined time period, wherein the historic data corresponds to a historical open platform communications (OPC) data from the one or more sources and an input data from at least one OPC client;
analyze the historic data using one or more artificial intelligence/machine learning (AI/ML) models to identify one or more events in the historic data;
identify one or more patterns associated with the identified one or more events using the one or more AI/ML models;
identify one or more root causes associated with each of the one or more patterns identified using the one or more AI/ML models;
correlate the identified one or more patterns with the identified one or more root causes; and
predict one or more anomalies and faults associated with the historic data, based at least on the correlation.

13. The system of claim 12, wherein the one or more sources comprise at least one of a scale, a remote terminal unit (RTU), a distributed control system (DCS), a programmable logic controller (PLC), or an analyzer, and wherein the predefined time period comprises at least one of a day, time, season, months, or years.

14. The system of claim 12, wherein the historical OPC data comprise at least one of the one or more events, one or more error messages, one or more keywords, one or more log messages, associated with one or more zones, and wherein the input data comprises at least one of an input request from the OPC client corresponding to reading and/or writing the historical OPC data, and wherein the one or more zones comprise at least one of a manufacturing plant, a power generation facility, an oil and gas refinery, a smart grid, and a transportation system of an industrial control system/Industrial Internet of Things (ICS/IIOT) environment.

15. The system of claim 14, wherein the at least one processor is configured to train the one or more AI/ML models using one or more AI/ML techniques, based at least on the received historic data, wherein the one or more AI/ML techniques comprise at least one of a supervised learning, an unsupervised learning, a rule based AI model, a natural language processing (NLP) model, an AI keyword search, a random forest, an extreme Gradient Boosting (XGBoost), or an ensembling technique.

16. The system of claim 15, wherein the NLP model is configured to associate one or more log messages from the historic data with one or more issues associated with the one or more zones, based at least on the analysis, wherein the one or more issues comprises at least one of an unauthorized action, a resource access, a file modification, and a process creation.

17. The system of claim 12, wherein the one or more events comprise at least one of communication lost with controller, access to remote server, station failure, calibration error, calibration cleared, channel hardware failure, configuration changed, device firmware mismatch, firmware downgraded, device duplicate address, rogue node connected, over temperature alert, sensor alert, short circuit detected, abrupt shutdown, parameter access lock changed, or controller CPU 90 percent (%).

18. The system of claim 12, wherein the one or more patterns comprise at least one of too many login failure event, an unauthorized elevated privilege event, a firmware version changed/downgraded event, a device index change event, or an erase master boot records and clear logs, backup and restore service stopped event.

19. The system of claim 12, wherein the one or more root causes comprise at least one of an unauthorized access, a privilege escalation, an unauthorized user/attacker trying to take advantage of vulnerable firmware, a possibility of intrusion/malware attack, or an intrusion and possibility of ransomware trying to stop backup.

20. A non-transitory machine-readable information storage medium comprising one or more instructions which when executed by at least one processor cause the at least one processor to:
receive a historic data from one or more sources for a predefined time period, wherein the historic data corresponds to a historical open platform communications (OPC) data from the one or more sources and an input data from at least one OPC client;
analyze the historic data using one or more artificial intelligence/machine learning (AI/ML) models to identify one or more events in the historic data;
identify one or more patterns associated with the identified one or more events using the one or more AI/ML models;
identify one or more root causes associated with each of the one or more patterns identified using the one or more AI/ML models;
correlate the identified one or more patterns with the identified one or more root causes; and
predict one or more anomalies and faults associated with the historic data, based at least on the correlation.
